(19) United States
(12) Patent Application Publication
(10) Pub. No.: US 2017/0050124 A1
(43) Pub. Date: Feb. 23, 2017

(54) LAMELLA SETTLER

(71) Applicant: Nordic Water Products AB, Västra Frölunda (SE)

(72) Inventor: Mattias FELDTHUSEN, Västra Frölunda (SE)

(73) Assignee: Nordic Water Products AB, Vasträ Frölunda (SE)

(21) Appl. No.: 15/307,743

(22) PCT Filed: Apr. 29, 2015
(86) PCT No.: PCT/SE2015/050481

§ 371 Date: Oct. 28, 2016

(30) Foreign Application Priority Data
Apr. 30, 2014 (SE) 1450518-4

(51) Int. Cl. B01D 21/00; B01D 21/24

(52) U.S. Cl. CPC B01D 21/0003; B01D 21/0045; B01D 21/2444

(57) ABSTRACT

A lamella settler (1) comprises a basin (10) with an inlet for liquid to be cleaned and a sludge outlet and with a plurality of outlet openings (12) for cleaned liquid. Each of a plurality of outlet flumes (16)connects to one of the plurality of outlet openings (12). A plurality of lamella plates are (18) attached to adjacent flumes (16). By providing a plurality of transverse beams (14) above the basin (10), wherein the outlet flumes (16) are supported by the beams (14), an improved lamella settler is achieved which is easier to manufacture and assemble and which has improved characteristics.

### TECHNICAL FIELD

The present invention relates generally to lamella settlers.

### BACKGROUND ART

So called lamella settlers for water treatment applications are known. The feed in the form of liquid enters the basin through a feed pipe. As the liquid flows upward between inclined parallel plates, wherein solids settle on the inclined plates and slide down the plate. Once the sludge has fallen off the plate it will settle into a sludge hopper at the bottom of a free-standing unit or onto the bottom of the sedimentation basin. In the hopper or on the bottom of the sedimentation basin, the sludge is thickened prior to discharge through a sludge outlet. The clarified liquid leaves the plate assembly through openings at the top and is discharged into collection channels leading to the clarified water outlet. An example of such a prior art lamella settler is shown in FIG. 1.

Even distribution of the flow to each plate ensures optimal operation at a high capacity. The side entry of the fluid prevents the solids that have settled from being carried away with the entering fluid.

However, there is a need for a simplified design of lamella settlers.

### SUMMARY OF INVENTION

An object of the present invention is to provide an improved lamella settler which is easier to manufacture and assemble and which has improved characteristics.

The invention is based on the realization that the lamella plates in the form of packages of a lamella settler can be supported from above.

Thus, according to the invention there is provided a lamella settler comprising: a basin with an inlet for liquid to be cleaned and a sludge outlet, a plurality of outlet openings for cleaned liquid, a plurality of outlet flumes, each connecting to one of the plurality of outlet openings, and a plurality of lamella plates attached to adjacent flumes, the lamella settler being characterized by a support structure provided above fluid contained in the basin, wherein the outlet flumes are supported by the support structure. By supporting the lamella plates from above, the space below the lamella plates is free from obstacles, facilitating removal of sludge from the basin.

In a preferred embodiment, the support structure comprises a plurality of transverse beams. Thereby, the flumes can be supported in a cost-efficient and still secure manner, preferably by means of threaded rods.

Other preferred embodiments are defined in the dependent claims.

### BRIEF DESCRIPTION OF DRAWINGS

The invention is now described, by way of example, with reference to the accompanying drawings, in which:

FIG. 1 is a perspective view of a prior art lamella settler; and

FIG. 2 is a perspective view of a lamella settler according to the invention.

### DESCRIPTION OF EMBODIMENTS

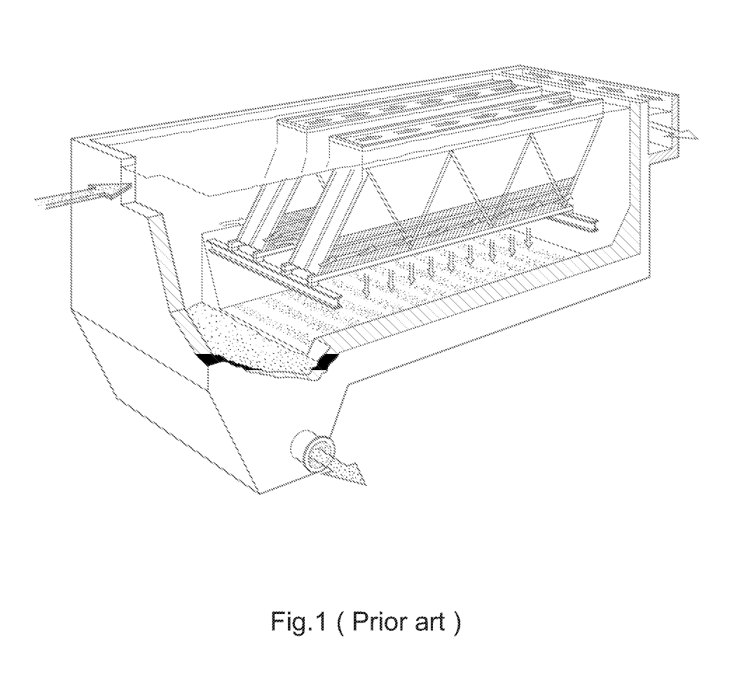

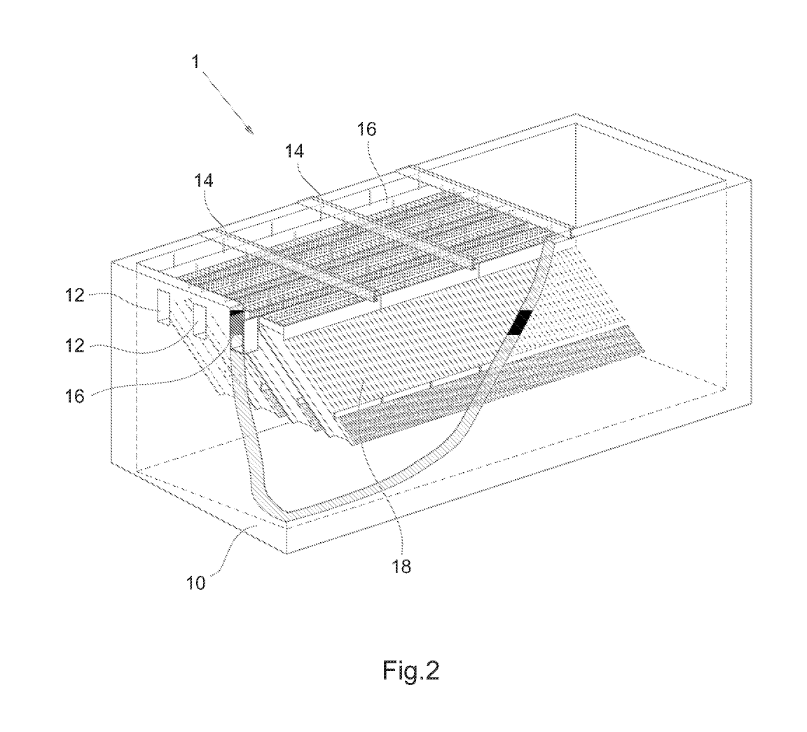

In the following, a detailed description of a lamella settler according to the invention will be given with reference to FIG. 2. This figure is a simplified drawing omitting parts, such as inlet and outlet for the fluid. It will be appreciated that the general layout of the lamella settler according to the invention may be like the prior art lamella settler shown in FIG. 1.

The lamella settler, generally designated 1, comprises a basin 10 which in a preferred embodiment is made of concrete. There is an inlet for liquid to be cleaned (not shown) and a sludge outlet at the bottom of the basin (not shown). In one of the end walls there is a plurality of outlet openings 12 for cleaned liquid.

A support structure in the form of plurality of transverse beams 14 are provided above the fluid contained in the basin 10, i.e., above the basin. These beams 14 are attached to the side walls of the basin 10. A plurality of outlet flumes 16 extend below the beams 14 and perpendicularly thereto, i.e., in the longitudinal direction of the basin 10. The outlet flumes 16 are supported by the beams 14 in a suitable way, such as by means of threaded rods extending from the beams.

The flumes 16 are mutually parallel and thus form a space there between. Attached between adjacent flumes 16 are inclined lamella plates 18 forming lamella packages. If the lamella plates are made of plastic, adjacent lamella plates are interconnected by means of grooves provided in the edges of the lamella plates. If the lamella plates are made of stainless steel, they are preferably interconnected by means of riveting. These lamella plates, which preferably are made of plastic, are attached to the flumes 16 by means of riveting, for example.

During operation, liquid flows upward between the inclined parallel plates, wherein solids settle on the inclined plates and slide down the plate. Once the sludge has fallen off the plate it will settle into a sludge hopper at the bottom of a free-standing unit or onto the bottom of the sedimentation basin. Since the lamella plates are supported from above, the space below them is free from any obstacles, simplifying removal of the sludge and thus improving the efficiency of the lamella settler.

A preferred embodiment of a lamella settler according to the invention has been described. It will be realized that this can be varied within the scope of the appended claims without departing from the inventive idea. Thus, instead of using threaded rods, alternative means, such as wires, can also be used to suspend the flumes.

1. A lamella settler (1) comprising:
a basin (10) with an inlet for liquid to be cleaned and a sludge outlet,
a plurality of outlet openings (12) for cleaned liquid,
a plurality of outlet flumes (16), each connecting to one of the plurality of outlet openings (12), and
a plurality of lamella plates (18) attached to adjacent flumes (16),
characterized by
a support structure (14) provided above the basin (10),
wherein the outlet flumes (16) are supported by the support structure (14).

2. The lamella settler according to claim 1, wherein the support structure comprises plurality of beams.

3. The lamella settler according to claim 2, wherein the flumes (16) extend perpendicular to the beams (14).

4. The lamella settler according to any one of claims 1-3, comprising threaded rods extending from the support structure (14) and being attached to the outlet flumes (16).

5. The lamella settler according to any one of claims 1-4, wherein the lamella plates (18) are made of plastic.

6. The lamella settler according to claim 5, wherein adjacent lamella plates are interconnected by means of grooves provided in the edges of the lamella plates.
